(19) United States
(12) Patent Application Publication
(10) Pub. No.: US 2014/0032511 A1
(43) Pub. Date: Jan. 30, 2014

(54) SEARCH DEVICE, A SEARCH METHOD AND A COMPUTER READABLE MEDIUM

(71) Applicant: DIGITAL ARTS INC., Tokyo (JP)

(72) Inventors: Noriyuki TAKAHASHI, Tokyo (JP); Toshio DOGU, Tokyo (JP)

(73) Assignee: DIGITAL ARTS INC., Tokyo (JP)

(21) Appl. No.: 14/038,701

(22) Filed: Sep. 26, 2013

Related U.S. Application Data
(63) Continuation of application No. PCT/JP2012/002090, filed on Mar. 26, 2012.

(30) Foreign Application Priority Data
Mar. 28, 2011 (JP) 2011-070902

(51) Int. Cl. G06F 17/30

(52) U.S. Cl. CPC G06F 17/30336
USPC 707/696; 707/722

(57) ABSTRACT

Provided is a search device including an acquiring section that acquires extraction target information indicating a feature of data to be extracted; an identification information extracting section that references a plurality of index files, which each associate pieces of feature information indicating features of a plurality of pieces of data with identification information identifying each piece of data, and extracts from the index files the identification information associated with feature information relating to the extraction target information; and a list creating section that determines whether there are identical pieces of identification information among the pieces of identification information extracted by the identification information extracting section, and creates an identification information list that does not include copies of identical pieces of identification information.

The contents of the following Japanese patent application and PCT patent application are incorporated herein by reference:
No. 2011-070902 filed on Mar. 28, 2011, and,
No. PCT/JP2012/002090 filed on Mar. 26, 2012.

### BACKGROUND

1. Technical Field

The present invention relates to a search device, a search method, and a computer readable medium.

2. Related Art

A search engine is known for searching for a file on the Internet or a file server. The search engine receives a search request from a user, acquires a list of files that match the search conditions, and transmits this list to the user, as shown in Patent Documents 1 and 2, for example.
Patent Document 1: Japanese Patent Application Publication No. 2005-122702
Patent Document 2: Japanese Patent Application Publication No. H9-265420

In order to simplify the file search, the search engine analyzes files and creates an index file. The search engine updates the index file every time a file is registered on the file server. However, the index file is provided as a single database for all of the files on the file server. Therefore, as the number of files on the file server increases, the load caused by updating the index file also increases.

### SUMMARY

Therefore, it is an object of an aspect of the innovations herein to provide a search device, a search system, a search method, and a program, which are capable of overcoming the above drawbacks accompanying the related art. The above and other objects can be achieved by combinations described in the claims. According to a first aspect of the present invention, provided is a search device comprising an acquiring section that acquires extraction target information indicating a feature of data to be extracted; an identification information extracting section that references a plurality of index files, which each associate pieces of feature information indicating features of a plurality of pieces of data with identification information identifying each piece of data, and extracts from the index files the identification information associated with feature information relating to the extraction target information; and a list creating section that determines whether there are identical pieces of identification information among the pieces of identification information extracted by the identification information extracting section, and creates an identification information list that does not include copies of identical pieces of identification information.

In the search device, the pieces of feature information may include information indicating a feature relating to a portion of each of the pieces of data. The search device may further comprise an index file updating section that updates an index file. The index file updating section may update a first index file until a predetermined event occurs, and when the predetermined event occurs, the index file updating section may create a second index file based on the first index file.

The search device may further comprise an access information extracting section that references a management file, in which the identification information for each piece of data is associated with access information indicating an access destination for the corresponding piece of data, and extracts from the management file the access information associated with the pieces of identification information that match the pieces of identification information included in the identification information list. The search device may further comprise a plurality of storage apparatuses that store the data and a management server that stores the management file and exchanges information with each of the storage apparatuses via a network. The search device may further comprise a request receiving section that receives a search request including the extraction target information from a user and an output section that presents the user with the identification information list, as a search result for the search request

According to a second aspect of the present invention, provided is a search system including a client terminal and a server that exchanges information with the client terminal via a network. The server includes the acquiring section that acquires extraction target information indicating a feature of data to be extracted; the identification information extracting section that references a plurality of index files, which each associate pieces of feature information indicating features of a plurality of pieces of data with identification information identifying each piece of data, and extracts from the index files the identification information associated with feature information relating to the extraction target information; and a transmitting section that transmits the pieces of identification information extracted by the identification information extracting section to the client terminal. The client terminal includes the list creating section that determines whether there are identical pieces of identification information among the pieces of identification information extracted by the identification information extracting section, and creates an identification information list that does not include copies of identical pieces of identification information.

According to a third aspect of the present invention, provided is a method comprising acquiring extraction target information indicating a feature of data to be extracted; referencing a plurality of index files, which each associate pieces of feature information indicating features of a plurality of pieces of data with identification information identifying each piece of data, and extracting from the index files the identification information associated with feature information relating to the extraction target information; and determining whether there are identical pieces of identification information among the extracted pieces of identification information, and creating an identification information list that does not include copies of identical pieces of identification information.

This method may further comprise updating an index file. Updating the index file may include updating a first index file until a predetermined event occurs, and when the predetermined event occurs, creating a second index file based on the first index file.

According to a fourth aspect of the present invention, provided is a method of a server providing service to a client terminal via a network. The service includes acquiring extraction target information indicating a feature of data to be extracted; referencing a plurality of index files, which each associate pieces of feature information indicating features of a plurality of pieces of data with identification information identifying each piece of data, and extracting from the index files the identification information associated with feature information relating to the extraction target information; and determining whether there are identical pieces of identification information among the extracted pieces of identification information, and creating an identification information list that does not include copies of identical pieces of identification information.

According to a fifth aspect of the present invention, provided is computer readable medium storing thereon a program for a search device. The program causes the computer to function as the search device or search system described above.

The summary clause does not necessarily describe all necessary features of the embodiments of the present invention. The present invention may also be a sub-combination of the features described above.

### BRIEF DESCRIPTION OF THE DRAWINGS

FIG. 1 is a schematic view of an exemplary system of an information processing apparatus 100.

FIG. 2 is a schematic view of an exemplary data configuration of an update index file 152.

FIG. 3 schematically shows an exemplary data configuration of a management file 172.

FIG. 4 is an outline of an exemplary method for updating the index file.

FIG. 5 shows an outline of an exemplary method of searching for data.

FIG. 6 shows an outline of an exemplary method for creating the identification information list.

FIG. 7 is a schematic view of an exemplary system configuration of an information processing apparatus 700.

FIG. 8 is a schematic view of a data configuration of the update index file 752.

FIG. 9 is a schematic view of an exemplary system configuration of an information processing apparatus 900.

FIG. 10 is a schematic view of an exemplary data configuration of the update index file 952.

FIG. 11 is a schematic view of a data configuration of the update index file 954.

FIG. 12 shows an example of a hardware configuration of a computer 1900 according to the present embodiment.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

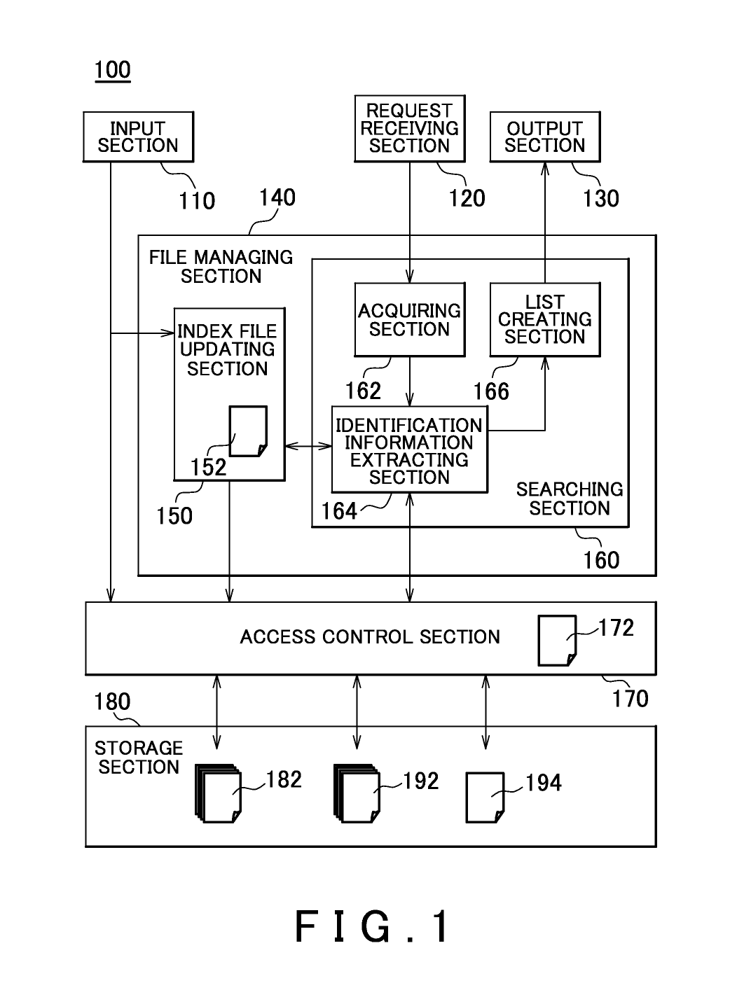

FIG. 1 is a schematic view of an exemplary system of an information processing apparatus 100. The information processing apparatus 100 may be a search engine or file management system that receives a search request from a user, creates a list of data files that match the search conditions, and presents this list to the user. The information processing apparatus 100 may be a system or controller specialized for this purpose, or may be a general information processing apparatus such as a personal computer, mobile terminal, or wireless terminal.

The information processing apparatus 100 includes an input section 110, a request receiving section 120, an output section 130, a file managing section 140, an access control section 170, and a storage section 180. The file managing section 140 includes an index file updating section 150 and a searching section 160. The searching section 160 includes an acquiring section 162, an identification information extracting section 164, and a list creating section 166. The information processing apparatus 100, the file managing section 140, and the searching section 160 are an example of a search device.

The index file updating section 150 may hold the update index file 152. The access control section 170 may hold the management file 172. The storage section 180 may store a data file 182, a temporary index file 192, and a master index file 194. The update index file 152, the temporary index file 192, and the master index file 194 are examples of a plurality of index files. The storage section 180 may store at least one of the update index file 152 and the management file 172.

The update index file 152, the temporary index file 192, and the master index file 194 store information (referred to hereinafter as “index information”) in which feature information indicating features of each piece of data is associated with identification information for identifying each piece of data. The temporary index file 192 is created based on the update index file 152. The master index file 194 is created based on a plurality of the temporary index files 192 or on a plurality of the temporary index files 192 and update index files 152.

The feature information may be information indicating a feature of data included in the data file. The data feature may be an attribute of the data file. The data file attribute may be a data format, a data type, data display or non-display, the creation date and time of the data, or the update date and time of the data. The data feature may be information indicating a request from the user for this data. The data feature may be information indicating that this data has been deleted. The feature information may include information indicating a feature relating to a portion of the data. If the data is text data, the data feature may be a portion of the text contained in the data. If the data is image data or video data, the data feature may be the color, chroma saturation, or brightness of the pixels forming the image included in the data.

The identification information may identify each of a plurality of data files. The identification information may be an identification number attached to a data file or the name of a data file. The identification information may indicate the location of data within the data file. If the data file includes a plurality of pieces of data that are temporally continuous, such as video data or sound data, the identification information may be associated with a time sequence. If the data file is video data, identification information may be attached to each frame.

The management file 172 may store information that associates identification information for each piece of data with access information indicating an access destination for each piece of data. The access information may indicate a storage location or reference destination of a data file. The access information may indicate a storage location or reference destination of a prescribed piece of data within a data file. The data file 182 may be data used by various types of software such as image data, text data, video data, or sound data, or may be a program such as software.

The input section 110 receives data stored in the storage section 180. The input section 110 may be an information reading apparatus or a communication apparatus that exchanges information with a storage device or a storage medium outside a computer. The data input to the input section 110 may be a data file such as image data, text data, video data, sound data, software, or data used by software. The input section 110 may receive the data file 182 from the outside, and transmit the data file 182 to the index file updating section 150. The input section 110 may store the data file 182 in the storage section 180, via the access control section 170.

The request receiving section 120 receives a request made to the information processing apparatus 100. The request receiving section 120 may be an input apparatus, character recognition apparatus, or sound recognition apparatus, such as a keyboard, mouse, touch panel, or microphone. The request receiving section 120 may be an information reading apparatus or a communication apparatus that exchanges information with an external computer, storage apparatus, or storage medium.

The request receiving section 120 receives from the user a search request that includes extraction target information indicating the data feature to be extracted. The data feature to be extracted may be a feature of a piece of data included in a data file. Examples of the extraction target information are the same as the examples of the feature information. The request receiving section 120 may transmit the extraction target information to the searching section 160. The request receiving section 120 is an example of an acquiring section.

The output section 130 presents the user with the search results for the search request. The output section 130 may be a display such as a liquid crystal display, an organic EL display, or a CRT display, or may be a printer or speaker. The output section 130 may be an information reading apparatus or a communication apparatus that exchanges information with an external computer, storage apparatus, or storage medium.

The output section 130 may receive from the searching section 160 a list of data files that match the search conditions of the user. The output section 130 may present to the user, as the search results for the user search request, the list received from the searching section 160. The output section 130 may receive information concerning the data file 182 access destination from the access control section 170, and present this information to the user. The output section 130 is an example of a transmitting section.

The file managing section 140 manages the data files stored in the storage section 180. The file managing section 140 creates or updates the index file whenever a data file 182 input from the input section 110 is stored in the storage section 180. The file managing section 140 receives the extraction target information from the request receiving section 120. The file managing section 140 may create a list of data files that match the extraction target information, from among the data files stored in the storage section 180. The file managing section 140 may create a list indicating locations of the pieces of data that match the extraction target information within the data file. The file managing section 140 transmits the created lists to the output section 130.

The index file updating section 150 updates the index file. The index file updating section 150 analyzes the data file 182 input from the input section 110, and extracts the feature information indicating the data features included in the data file 182. The index file updating section 150 creates index information in which the extracted feature information is associated with the identification information identifying the data file 182 or the data included in the data file 182. The index file updating section 150 compares the created index information to the index information included in the update index file 152, and changes, adds, or deletes pieces of index information to update the update index file 152.

The index file updating section 150 may also update the update index file 152 when instructions for deleting a data file 182 are received from the request receiving section 120. The update index file 152 may be stored in a storage apparatus having higher response speed than the storage section 180. The update index file 152 may be stored in a memory.

The index file updating section 150 updates the update index file 152 whenever a data file 182 input from the input section 110 is stored in the storage section 180, until a predetermined event occurs. When the predetermined event occurs, the index file updating section 150 outputs the index information included in the update index file 152 as a temporary index file 192, and stores this file in the storage section 180. The update index file 152 is an example of a first index file. The temporary index file 192 is an example of a second index file.

The predetermined event may be that a predetermined time has passed from when the update index file 152 was created. The predetermined event may be that a predetermined time has passed from the previous instance of the index information included in the update index file 152 being output to the storage section 180. The predetermined event may be that the update index file 152 has exceeded a predetermined size. The predetermined event may be that the request receiving section 120 has received a search request from the user. The predetermined event may be that the index file updating section 150 has created a master index file 194.

With the present embodiment, the update index file 152 can be made smaller than in a case where the index file is provided as a single database for all of the files on the file server. Therefore, the load for updating the index file can be significantly reduced. Furthermore, the time required to update the index file can be greatly reduced. As a result, sufficient processing speed can be realized even when using a general device, and the cost of configuring the information processing apparatus 100 can be reduced.

Using these features, the index file updating section 150 may create a plurality of update index files 152 and update the plurality of update index files 152 whenever a data file 182 input from the input section 110 is stored in the storage section 180. The index file updating section 150 may select which update index file 152 to update based on the data format of the data file 182. The index file updating section 150 may select which update index file 152 to update based on the person who created, input, or transmitted the data file. In this way, the amount of index information that is targeted during a search can be decreased.

The index file updating section 150 may divide the pieces of data in the update index file 152 based on a predetermined rule, and output these pieces of data as a plurality of temporary index files 192. In this way, the identification information extracting section 164 can search the plurality of temporary index files 192 in parallel. As a result, the time needed to update the index file can be greatly reduced.

The index file updating section 150 may divide a plurality of pieces of index information included in the update index file 152 into a plurality of temporary index files 192, such that each temporary index file 192 has a predetermined size. The index file updating section 150 may use random numbers to divide a plurality of pieces of index information included in the update index file 152 into a plurality of temporary index files 192.

The index file updating section 150 may divide a plurality of pieces of index information included in the update index file 152 into a plurality of temporary index files 192 based on the information associating the identification information identifying each piece of data with a type of each piece of data. The index file updating section 150 may divide a plurality of pieces of index information included in the update index file 152 into a plurality of temporary index files 192 based on information associating a plurality of pieces of feature information with a type of each piece of feature information.

The index file updating section 150 may output to the storage section 180 the index information included in the current update index file 152, and then delete the current update index file 152 and create a new update index file 152. The index file updating section 150 may output to the storage section 180 the index information included in the current update index file 152, and then clear the index information included in the update index file 152.

The index file updating section 150 may create of update the master index file 194 when a predetermined event occurs, based on a plurality of temporary index files 192 or on a plurality of temporary index files 192 and the update index file 152. The predetermined event may be that a predetermined time has passed from when the master index file 194 was created or updated. The predetermined event may be that it has become a predetermined time. The master index file 194 can be created or updated by combining the pieces of index information included in a plurality of index files and deleting any copies of the same piece of index information, for example. The index file updating section 150 may create the master index file 194, and then delete the temporary index files 192.

The searching section 160 creates search results for the search request from the user. The searching section 160 receives the extraction target information from the request receiving section 120. The searching section 160 may create a list of data files that match the extraction target information from among the data files stored in the storage section 180. The searching section 160 may create a list indicating the locations of pieces of data matching the extraction target information in the data file. The searching section 160 transmits the created list to the output section 130.

The acquiring section 162 acquires the extraction target information indicating the data feature to be extracted. The acquiring section 162 may acquire the extraction target information from the request receiving section 120. The acquiring section 162 transmits the acquired extraction target information to the identification information extracting section 164.

The identification information extracting section 164 references a plurality of index files in which the identification information identifying each piece of data is associated with the feature information identifying the feature of each piece of data, and extracts from these index files the identification information associated with feature information relating to the extraction target information. The identification information extracting section 164 may reference one or more temporary index files 192 and the master index file 194, and extract the identification information from these index files. The identification information extracting section 164 may further reference an update index file, and extract the identification information from the update index file.

The identification information extracting section 164 may extract not only the identification information associated with the same feature information as the extraction target information, but also the identification information associated with feature information similar to the extraction target information. If the data is text data, the identification information extracting section 164 may extract identification information associated with character sequences that are of the same language as or synonymous with the character sequence that is the extraction target information. If the data is image data, video data, or sound data, the identification information extracting section 164 may compare the extraction target information to the feature information stored in the index file and, if a degree of matching for an image or sound is above a predetermined threshold, may extract identification information associated with this feature information.

The list creating section 166 determines whether a plurality of the same pieces of identification information are included among the pieces of identification information extracted by the identification information extracting section, and creates an identification information list that does not include copies of identical pieces of identification information. The list creating section 166 sends the identification information list to the output section 130, as the search results for the search request.

With the present embodiment, the index file is not provided as a single database. With the present embodiment, the index file is provided as a plurality of databases. Therefore, the load of updating the index file is significantly reduced. Furthermore, index file searches can be performed in parallel, and therefore the time needed to update the index file can be greatly reduced.

Each index file is created such that, when searched, no copies of pieces of identification information are extracted. However, the identification information extracting section 164 references the index files and extracts from the index files pieces of identification information that are candidates for results of the search. Therefore, among the pieces of identification information extracted by the identification information extracting section 164, there may be copies of the same pieces of identification information.

With the present embodiment, the list creating section 166 creates an identification information list that does not include any copies of identical pieces of identification information, based on the pieces of identification information extracted by the identification information extracting section. Therefore, even when the index file is provided as a plurality of databases, search results that do not contain copies can be provided. When comparing the update frequency of the index file, this effect is even greater when the search requests are received infrequently. This effect is also greater when the index file update takes a long time, such as in a case where data files are stores in distributed storage on a network.

The access control section 170 controls access to the storage section 180. The access control section 170 may reference the management file 172 and extract from the management file 172 access information associated with identification information matching the identification information included in the identification information list. The access control section 170 is an example of an access information extracting section.

The access control section 170 may receive data files 182 from the input section 110 and store the data files 182 in the storage section 180. At this time, the access control section 170 may update the management file 172. The access control section 170 may receive the temporary index file 192 from the index file updating section 150 and store the temporary index file 192 in the storage section 180. At this time, the access control section 170 may update the management file 172.

The access control section 170 may receive an access request for the master index file 194 and the temporary index file 192 from the identification information extracting section 164, and send to the identification information extracting section 164 information indicating an access destination of the master index file 194 and the temporary index file 192. The access control section 170 may receive the access request for a data file 182 from the request receiving section 120, and send to the output section 130 information of an access destination of the data file 182.

The storage section 180 stores data. The storage section 180 may be a storage apparatus or a storage medium such as a hard disk, CD-ROM, IC card, or flash memory. The storage section 180 may be a virtual or cloud storage apparatus or storage medium. The storage section 180 may be a memory such as a ROM, a RAM, or a cache memory. The storage section 180 is an example of a storage apparatus.

The information processing apparatus 100 and each component of the information processing apparatus 100 may be realized by hardware, or by software. The information processing apparatus 100 may be a system specialized for a certain use, or may be a general information processing apparatus such as a personal computer. A specialized system such as described above and the information processing apparatus may be formed by a single computer, or may be formed by a plurality of computers distributed over a network.

The information processing apparatus 100 may execute a program to cause a computer to function as the information processing apparatus 100. In an information processing apparatus with a common configuration including an input apparatus, an output apparatus, a storage apparatus, and a data processing apparatus such as a CPU, ROM, RAM, and a communication interface, the information processing apparatus 100 may be realized by initiating software in which the operation of each component of the information processing apparatus 100 is defined.

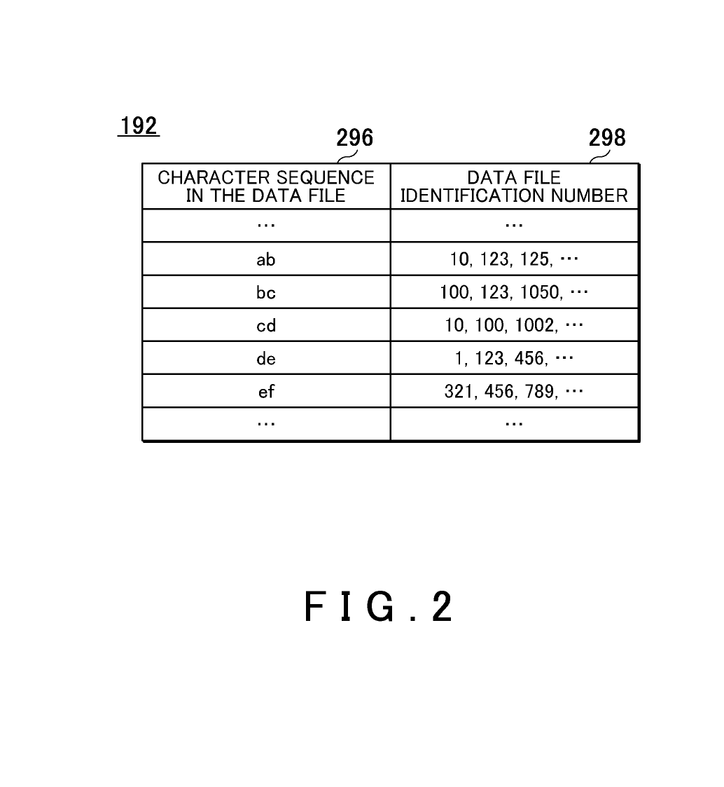

FIG. 2 is a schematic view of an exemplary data configuration of a temporary index file 192. FIG. 2 schematically shows an exemplary data configuration of a temporary index file 192 in a case where the data file is text data. The update index file 152 and the master index file 194 may have the same data configuration as the temporary index file 192.

The temporary index file 192 may store index information in which a character sequence 296 included in the data file is associated with an identification number 298 identifying the data file. The character sequence 296 may be obtained by dividing a character sequence included in the data file into character units. The character sequence 296 is an example of feature information. The identification number 298 is an example of identification information.

The identification information extracting section 164 can extract from the temporary index file 192 the identification information associated with the feature information relating to the extraction target information using the following process, for example. The identification information extracting section 164 divides the extraction target information into character sequences having the same length as the character sequences stored in the temporary index file 192. If the extraction target information is “abc,” then the extraction target information includes the character sequences “ab” and “bc.”

Next, the identification information extracting section 164 references the temporary index file 192 and searches for identification numbers of data files in which the character sequence “ab” is included. In FIG. 2, the identification numbers of data files that include the character sequence “ab” are found to be numbers “10,” “123,” “125,” etc. Furthermore, the identification information extracting section 164 references the temporary index file 192 and searches for identification numbers of data files in which the character sequence “bc” is included. In FIG. 2, the identification numbers of data files that include the character sequence “bc” are found to be numbers “100,” “123,” “1050,” etc.

The identification information extracting section 164 compares the identification numbers of the data files that include the character sequence “ab” to the identification numbers of the data files that include the character sequence “bc,” and extracts the identification numbers that include both character sequences as the identification information associated with the feature information relating to the extraction target information. In this case, the data file having the identification number “123” is extracted.

The content of the index file, the data configuration, and the like are not particularly limited. The index file must simply be a collection of information obtained by analyzing the content of data.

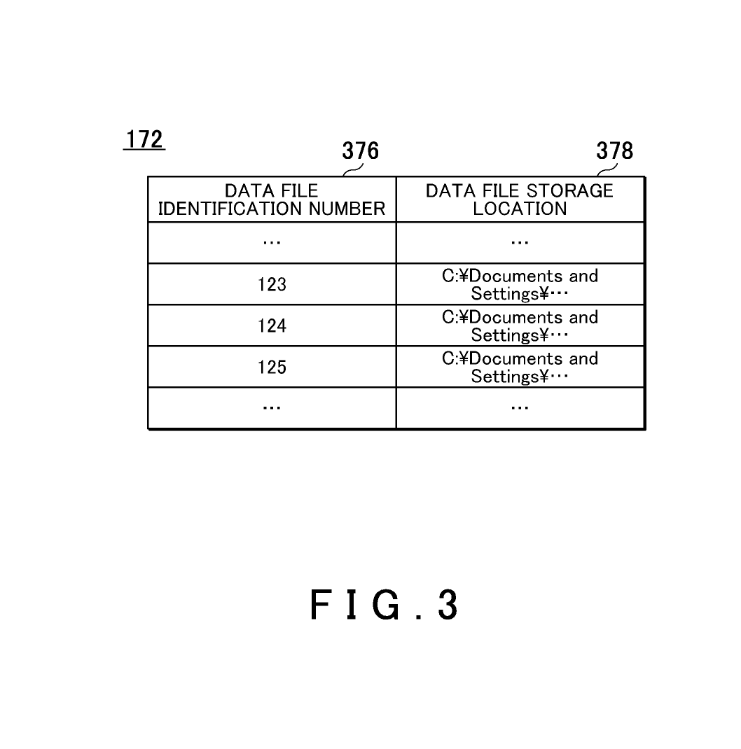

FIG. 3 schematically shows an exemplary data configuration of a management file 172. The management file 172 may store information in which the identification number 376 identifying the data file is stored in association with the storage location 378 of the data file. The identification number 376 is an example of identification information. The access control section 170 can extract from the management file 172 the access information associated with the identification information.

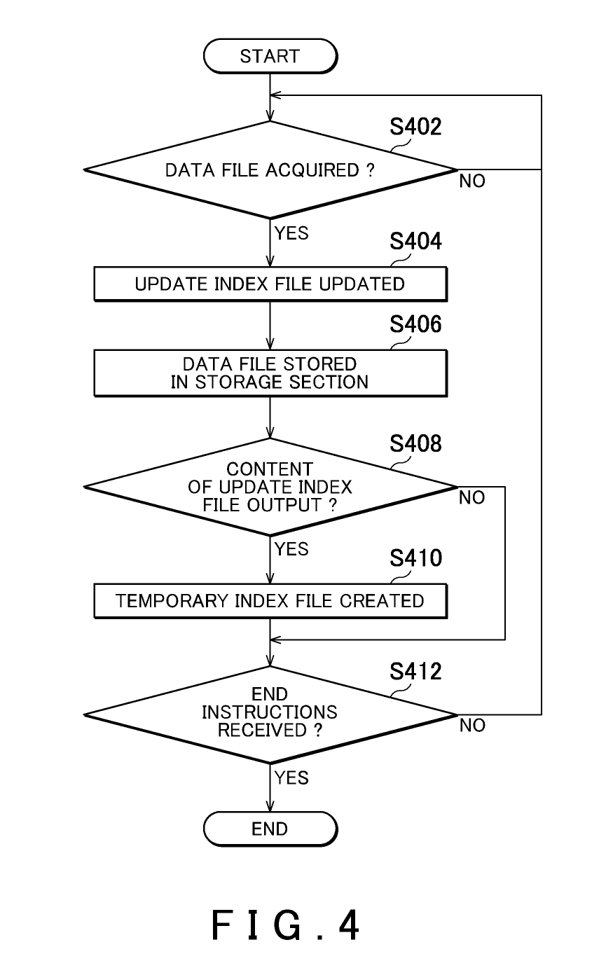

Next, FIGS. 4, 5, and 6 are used to describe an outline of the information processing performed by the information processing apparatus 100. FIG. 4 is an outline of an exemplary method for updating the index file. At S402, the input section 110 determines whether a data file 182 has been input. If the input section 110 determines that a data file 182 has not been input (the “No” of S402), the information processing apparatus 100 remains in standby. If the input section 110 determines that a data file 182 has been input (the “Yes” of S402), at S404, the index file updating section 150 analyzes the data file 182 and updates the update index file 152. At S406, the access control section 170 stores the data file 182 in the storage section 180. At this time, the access control section 170 may update the management file 172.

At S408, the index file updating section 150 determines whether the predetermined event has occurred. If the index file updating section 150 determines that the predetermined event has occurred (the “Yes” of S408), at S410, the index file updating section 150 outputs to the access control section 170, as the temporary index file 192, the index information included in the update index file 152. The access control section 170 stores the temporary index file 192 in the storage section 180. At this time, the access control section 170 may update the management file 172.

At S408, if the index file updating section 150 determines that the predetermined event has not occurred (the “No” of S408), at S412, the request receiving section 120 determines whether the end instructions have been received from the user. Also, at S410, if the access control section 170 has stored the temporary index file 192 in the storage section 180, at S412, the request receiving section 120 determines whether end instructions have been received from the user.

At S412, if the request receiving section 120 has determined that end instructions have not been received from the user (the “No” of S412), the information processing apparatus 100 moves to standby. At S412, if the request receiving section 120 has determined that end instructions have been received from the user (the “Yes” of S412), the information processing apparatus 100 ends the process.

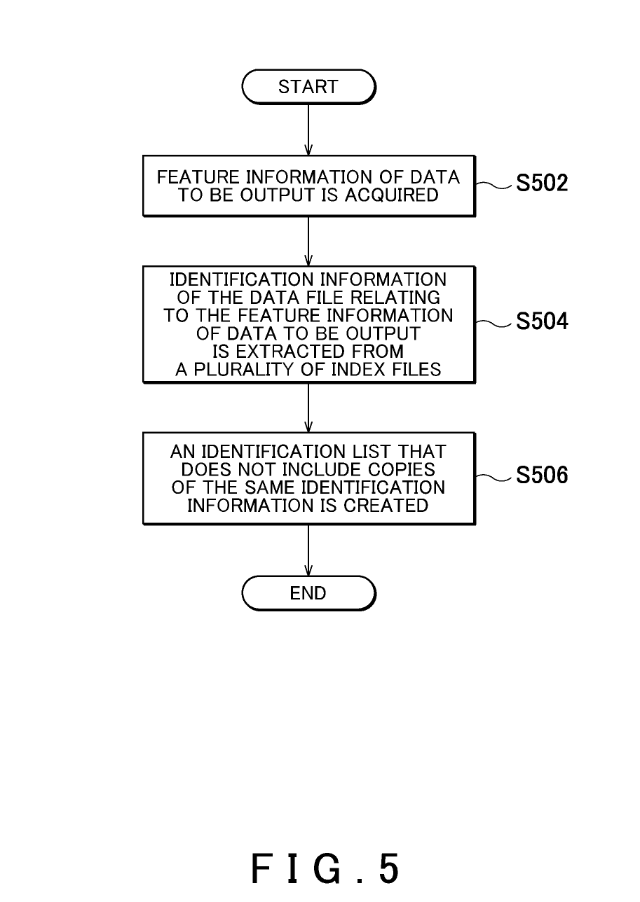

FIG. 5 shows an outline of an exemplary method of searching for data. At S502, the request receiving section 120 receives a search request from the user that includes extraction target information indicating a feature of the data to be extracted. The request receiving section 120 transmits the extraction target information to the acquiring section 162. The acquiring section 162 transmits the acquired extraction target information to the identification information extracting section 164.

At S504, the identification information extracting section 164 creates the search results by referencing a plurality of the index files and extracting from the index files the identification information associated with the feature information relating to the extraction target information. The search results include the identification information extracted by the identification information extracting section 164. The identification information extracting section 164 may create search results for each of a plurality of index files, from the results of a search of each of the plurality of index files. The identification information extracting section 164 transmits the search results to the list creating section 166. At S506, the list creating section 166 receives the search results from the identification information extracting section 164. The list creating section 166 determines whether a plurality of the same piece of identification information are present among the pieces of identification information extracted by the identification information extracting section 164, and creates the identification information list such that copies of identical pieces of identification information are not included.

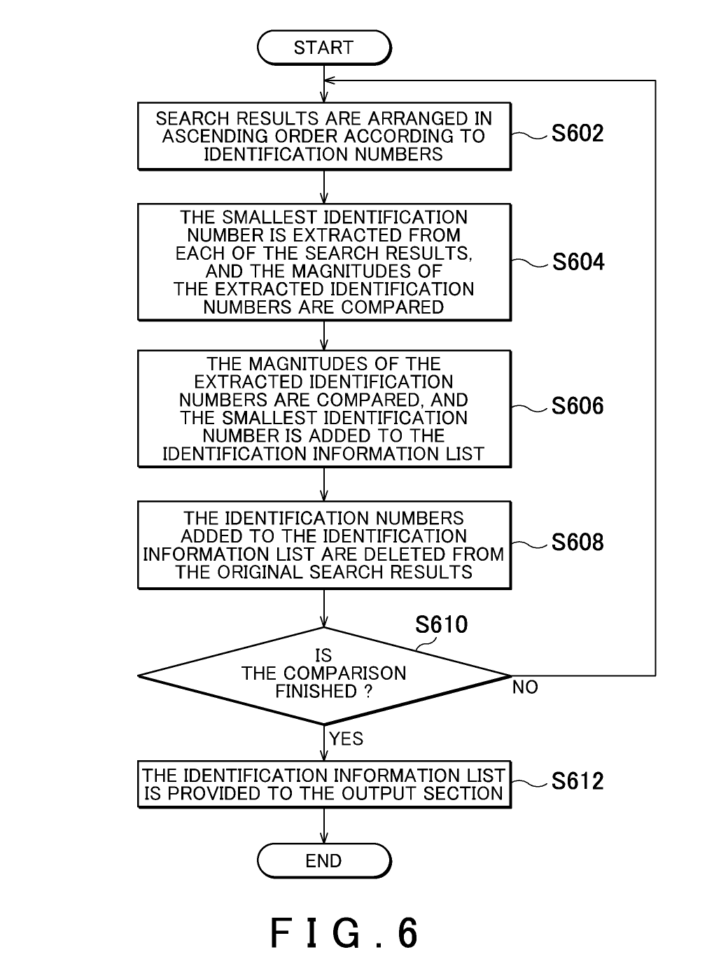

FIG. 6 shows an outline of an exemplary method for creating the identification information list. FIG. 6 shows an outline of an exemplary method by which the list creating section 166 creates the identification information list at S506 described in FIG. 5. As described above, at S506, the list creating section 166 receives from the identification information extracting section 164 a plurality of search results corresponding to each of a plurality of index files.

The following describes a method of creating an identification information list using an example in which an identification information list X is created using search result A, search result B, and search result C received from the identification information extracting section 164. The search result A includes the data files with identification numbers of 1, 3, 3, 5, and 6, as the identification information. The search result B includes the data files with identification numbers of 3, 4, 5, 7, and 8, as the identification information. The search result C includes the data files with identification numbers of 2, 5, 6, and 7, as the identification information.

At S602, the list creating section 166 arranges the pieces of identification information in ascending order for each of the search results. At this time, if copies of the same pieces of identification information are included in any one of the search results, these copies may be deleted. Therefore, in the present embodiment, identification numbers included in the search result A are arranged in the order of 1, 3, 5, 6. The pieces of identification information in the other search results are arranged in the same manner.

At S604, the list creating section 166 extracts the smallest identification number from among each search result. In the present embodiment, the list creating section 166 extracts the identification number 1 from the search result A. In the same manner, the list creating section 166 extracts the identification number 3 and the identification number 2 respectively from the search result B and the search result C.

At S606, the list creating section 166 compares the magnitudes of the extracted identification numbers, and adds the smallest identification number to the identification information list. In the present embodiment, the list creating section 166 makes a comparison between the identification number 1 extracted from the search result A, the identification number 3 extracted from the search result B, and the identification number 2 extracted from the search result C. As a result, the list creating section 166 adds the identification number 1 extracted from the search result A to the identification information list X.

If the identification numbers extracted from a plurality of search results are the same, the identification number to be added to the identification information list X may be determined according to a predetermined order of priority. For example, priority may be determined among the plurality of search results. In the present embodiment, the search result A, the search result B, and the search result C are prioritized in the stated order.

At S608, the list creating section 166 deletes from the search results the identification number that has been added to the identification information list. In this case, the list creating section 166 deletes the identification number 1 from the search result A. As a result, the search result A includes the identification numbers 3, 5, 6.

At S610, the list creating section 166 determines whether the comparisons have been finished. If the list creating section 166 determines at S610 that the comparisons are finished (the “Yes” of S610), at S612, the list creating section 166 transmits the identification information list to the output section 130 and the process ends. If the list creating section 166 determines at S610 that the comparisons are not finished (the “No” of S610), the steps from S602 to S610 are repeated.

In the present embodiment, the search results A, B, and C still include identification numbers, and therefore the list creating section 166 determines that the comparisons are not finished and repeats the steps from S602 to S610. As a result, ultimately, the list creating section 166 transmits to the output section 130 the identification information list X including the identification numbers 1, 2, 3, 4, 5, 6, 7, 8.

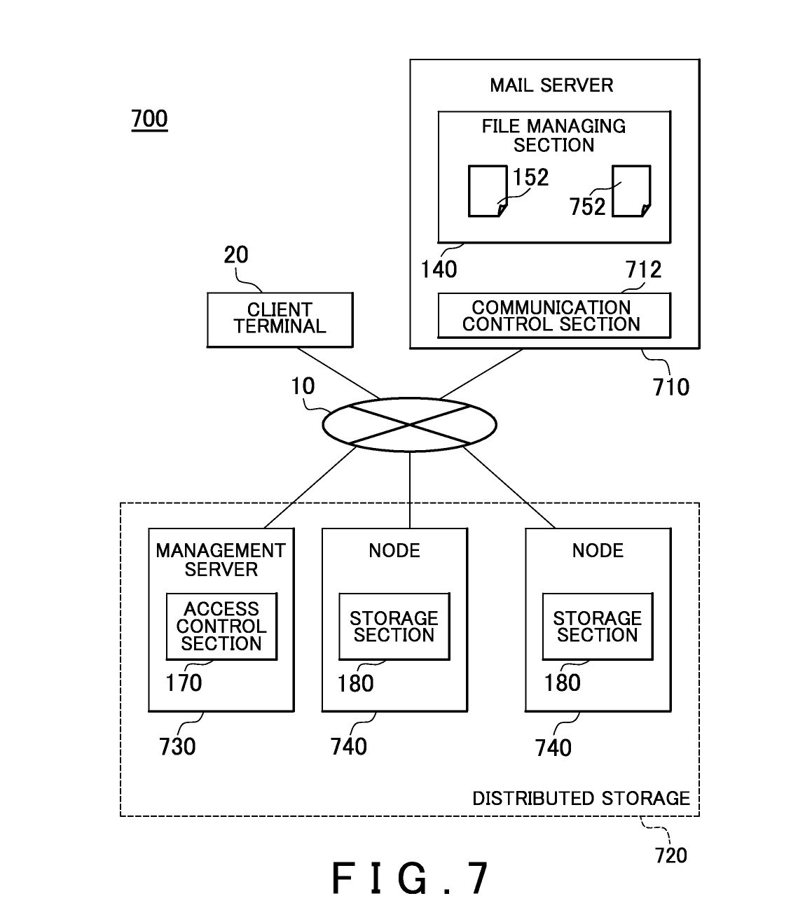

FIG. 7 is a schematic view of an exemplary system configuration of an information processing apparatus 700. FIG. 7 shows the information processing apparatus 700 together with a network 10 and a client terminal 20. The network 10 may be the Internet, a dedicated line, or a wireless packet communication network. The client terminal 20 need only be an apparatus that can exchange information with a mail server 710 and a distributed storage 720 via the network 10, and may be a personal computer, mobile phone, mobile terminal, or wireless terminal with a web browser installed thereon. The client terminal 20 may be a system or controller specialized for a certain use, or may be a general information processing apparatus such as a personal computer.

The information processing apparatus 700 may be a mail management system that stores received mail, receives a search request from the user, creates a list of mail matching the search conditions, and presents this list to the user. The information processing apparatus 700 includes the mail server 710 and the distributed storage 720. The mail server 710 includes the file managing section 140 and a communication control section 712. The file managing section 140 may hold the update index file 152 and an update index file 752. The distributed storage 720 includes a management server 730 and one or more nodes 740. The management server 730 includes the access control section 170. Each of the one or more nodes 740 may include a storage section 180.

The data file 182, the temporary index file 192, and the master index file 194 may be stored in the storage section 180. The data file 182, the temporary index file 192, and the master index file 194 may be distributed and stored on a plurality of the storage sections 180. The information processing apparatus 700 and the mail server 710 are an example of a search device. The information processing apparatus 700 and the mail server 710 are an example of a search system server.

The information processing apparatus 700 differs from the information processing apparatus 100 in that the file managing section 140 exchanges information with the access control section 170 and the storage section 180 via the network 10. The information processing apparatus 700 further differs from the information processing apparatus 100 in that the data file 182, the temporary index file 192, and the master index file 194 are stored in the distributed storage 720. The information processing apparatus 700 yet further differs from the information processing apparatus 100 in that the file managing section 140 analyzes the data file and updates a plurality of update index files.

Concerning all other points, the information processing apparatus 700 may have the same configuration as the information processing apparatus 100. Components of the information processing apparatus 700 that are the same as or similar to components of the information processing apparatus 100 are given the same reference numeral, and redundant descriptions are omitted. Furthermore, the information processing apparatus 100 may have the same configuration as the information processing apparatus 700.

The mail server 710 exchanges information with the client terminal 20, the management server 730, and the plurality of nodes 740 via the network 10. The mail server 710 receives mail, and stores the received mail in the distributed storage 720. The mail server 710 analyzes the received mail and updates the update index file 152.

When a predetermined event occurs, the mail server 710 outputs the index information included in the update index file 152 as the temporary index file 192, and transmits the temporary index file 192 to the distributed storage 720. The mail server 710 receives a search request from the client terminal 20. The mail server 710 creates an identification information list that includes the identification information of mail matching the search conditions. The mail server 710 presents the user with the identification information list, as the search results for the search request.

The mail server 710 may be configured as a single server, or may be configured as a plurality of servers. The mail server 710 may be a virtual server or cloud system. The mail server 710 may be a system or controller specialized for a certain use, or may be a general information processing apparatus such as a personal computer. The mail server 710 exchanges information with the client terminal 20, the management server 730, and the nodes 740 via the communication control section 712. The communication control section 712 may be an interface that exchanges information with another computer, mobile phone, mobile terminal, wireless terminal, storage apparatus, or storage medium via the network 10. The communication control section 712 is an example of a transmitting section.

In the present embodiment, the index file updating section 150 holds the update index file 752 in addition to the update index file 152. The index file updating section 150 analyzes the data file 182 and updates the update index file 152 and the update index file 752. The index file updating section 150 may create a corresponding temporary index file and a master index file for each of the update index file 152 and the update index file 752.

The update index file 752 may store index information in which different types of feature information than the update index file 152 are associated with identification information of data. In this way, a variety of search requests can be handled. Furthermore, more accurate search results can be presented.

For example, the update index file 152 may store index information in which the character sequence included in the data file is associated with the identification number identifying this data file. The update index file 752 may store index information in which a request for the data file from the user is associated with the identification number identifying this data file.

When the mail server 710 receives a search request for mail that includes the character sequence “abc,” the identification information extracting section 164 may reference the temporary index file and the master index file corresponding to the update index file 152, and create an identification information list A that lists the identification information of mails including the character sequence “abc.” Furthermore, the identification information extracting section 164 may reference the temporary index file and the master index file corresponding to the update index file 752, and create an identification information list B that lists the identification information of mails that have been deleted or are set to not be displayed.

The identification information extracting section 164 may compare the identification information list A to the identification information list B, and create an identification information list C by deleting from the identification information list A the identification information included in the identification information list B. The mail server 710 may then present the user with the identification information list C as the search result for the search request. In this way, the user can be presented with only the search results that are to be shown to the user.

The distributed storage 720 stores the data received from the mail server 710. The distributed storage 720 may store a single data file in a distributed manner in a plurality of nodes 740. The management server 730 manages the data stored in the node 740. The management server 730 may store the management file 172. The management server 730 may exchange information with the mail server 710 and each of the storage sections 180, via the network 10. The management server 730 may be a system or controller specialized for a certain use, or may be a general information processing apparatus such as a personal computer. The management server 730 may be a virtual server or a cloud system.

Each node 740 stores data. The node 740 may exchange information with the mail server 710 and the management server 730 via the network 10. The node 740 may be a system or controller specialized for a certain use, or may be a general information processing apparatus such as a personal computer or a storage medium or storage apparatus such as a hard disk. The node 740 may be a virtual or cloud storage apparatus or storage medium.

When an index file provided as a single database for all files in a file server is stored in the distributed storage 720, as in the prior art, the time needed to update this index file is much longer than in a case where the index file is stored in a local storage apparatus. However, with the present embodiment, the update index file 152 stored in the storage apparatus of the mail server 710 is used to update the index file. On the other hand, the temporary index file 192 and the master index file 194 are stored in the distributed storage 720 and are not constantly updated. Therefore, compared to a case in which the index file is provided as a single database for all files in a file server, the time needed to update the index file can be greatly reduced. The storage apparatus of the mail server 710 is an example of a local storage device.

The present embodiment describes an example in which the update index file 152 is stored in the mail server 710 and the temporary index file 192 and the master index file 194 are stored in the distributed storage 720. However, the storage location of the update index file 152 is not limited to the mail server 710. Instead, the update index file 152 may be stored in the distributed storage 720. In this case as well, the size of the update index file 152 is smaller than in a case where the index file is provided as a single database for all files in a file server, and therefore the time needed to update the index file can be reduced.

Furthermore, with the present embodiment, a plurality of index files can be referenced when a search is performed. Therefore, index file searches can be performed in parallel, and so the search time can be reduced. In a mail management system, the frequency at which a mail search is performed is much lower than the frequency at which mail is received. Therefore, the effects realized by providing the index file as a plurality of databases are even more significant.

The present embodiment describes an example in which the mail server 710 includes the entirety of the file managing section 140. However, the information processing apparatus 700 is not limited to this. For example, the searching section 160 and the list creating section 166 of file managing section 140 may instead be included in the client terminal 20.

In this case, the identification information extracting section 164 of the mail server 710 extracts from the index files the identification information associated with the feature information relating to the extraction target information. The communication control section 712 transmits to the client terminal 20 the one or more pieces of identification information extracted by the identification information extracting section 164. The list creating section 166 of the client terminal 20 determines whether identical pieces of identification information are included among the one or more pieces of identification information extracted by the identification information extracting section 164, and creates an identification information list that does not include copies of the same piece of identification information.

The mail server 710 may instruct a program operating on the client terminal 20 to create the identification information list. The mail server 710 may transmit to the client terminal 20 a program for creating the identification information list. The system including the information processing apparatus 700 and the client terminal 20 is an example of a search system.

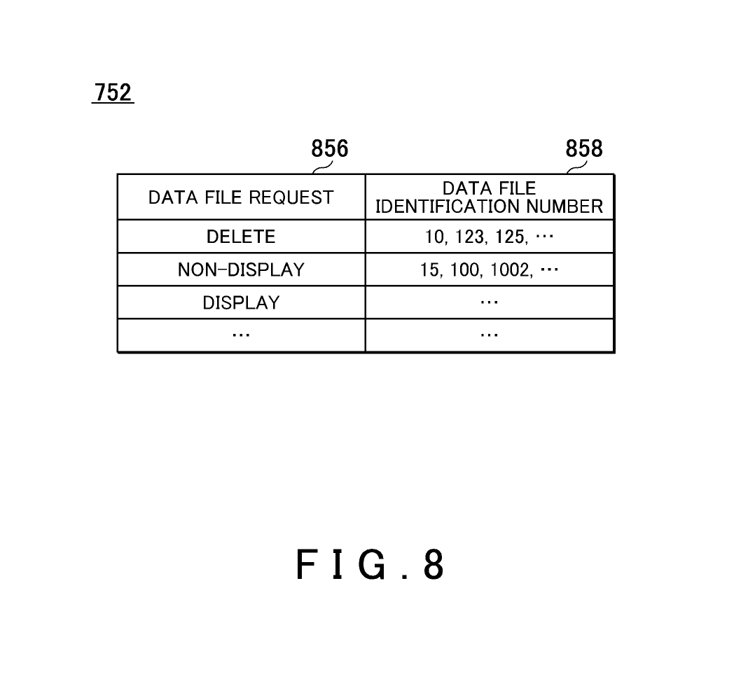

FIG. 8 is a schematic view of a data configuration of the update index file 752. The update index file 752 may store index information in which a request 856 for a data file is associated with the identification number 858 identifying the data file. The request 856 is an example of feature information. The identification number 858 is an example of identification information.

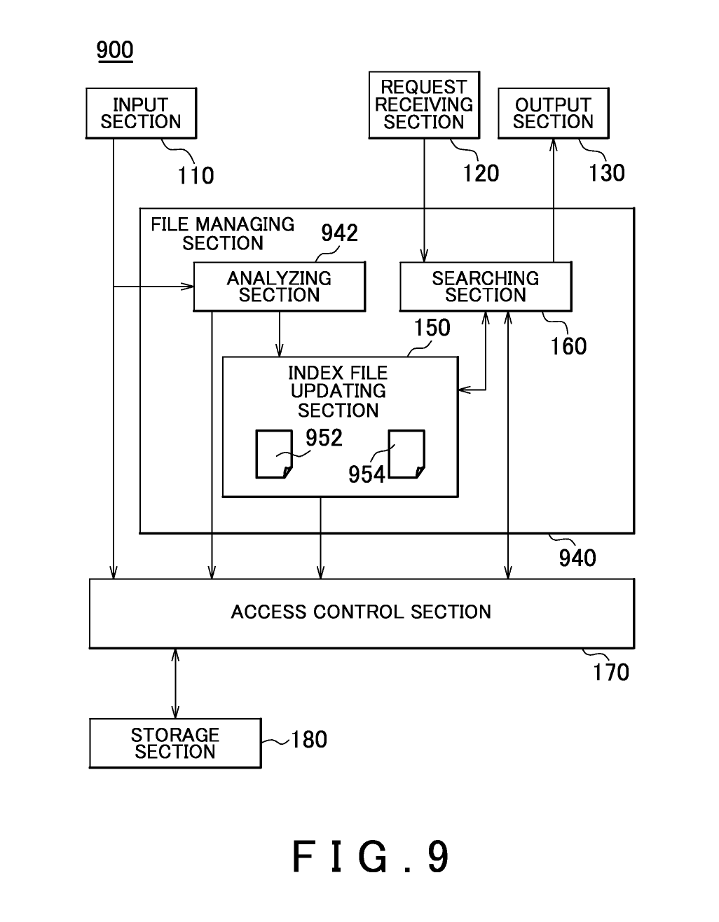

FIG. 9 is a schematic view of an exemplary system configuration of an information processing apparatus 900. The information processing apparatus 900 may be a system that receives a search request from the user, extracts data matching the search conditions from within a data file including a plurality of pieces of data that are temporally continuous, and presents the extracted data to the user. The data file including a plurality of pieces of data that are temporally continuous may be video data or sound data.

The information processing apparatus 900 includes the input section 110, the request receiving section 120, the output section 130, a file managing section 940, the access control section 170, and the storage section 180. The file managing section 940 includes an analyzing section 942, the index file updating section 150, and the searching section 160. The index file updating section 150 may hold an update index file 952 and an update index file 954. The storage section 180 may store the data file 182, the temporary index file 192, and the master index file 194. The information processing apparatus 900 and the file managing section 940 are an example of a search device.

The information processing apparatus 900 differs from the information processing apparatus 100 and the information processing apparatus 700 in that the file managing section 940 includes the analyzing section 942. Concerning all other points, the information processing apparatus 900 may have the same configuration as the information processing apparatus 100 or the information processing apparatus 700. Components of the information processing apparatus 900 that are the same as or similar to components of the information processing apparatus 100 or the information processing apparatus 700 are given the same reference numeral, and redundant descriptions are omitted. Furthermore, the information processing apparatus 900 may have the same configuration as the information processing apparatus 100 or the information processing apparatus 700.

The information processing apparatus 900 stores in the storage section 180 a data file 182 input by the input section 110. The information processing apparatus 900 analyzes the data file 182 and updates the update index file 952 and the update index file 954. The information processing apparatus 900 receives a search request from the user input to the request receiving section 120. The information processing apparatus 900 creates an identification information list that includes identification information of the data files 182 matching the search conditions. The information processing apparatus 900 presents the user with this identification information list as the search results for the search request.

If a plurality of data files are included in a single data file, the analyzing section 942 analyzes each data file. As an example of a case in which a plurality of data files are included in a single data file, a plurality of pieces of image data may be included in a single data file or a plurality of pieces of data that are temporally continuous may be included in a single data file.

For ease of explanation, the analyzing section 942 is described using an example in which the data file is video data including a plurality of pieces of image data that are temporally continuous. The analyzing section 942 receives the data file 182 input from the input section 110. The analyzing section 942 determines whether the data file 182 is video data. The analyzing section 942 may determine whether the data file 182 is video data based on the data format of the data file. If it is determined that the data file 182 is not video data, the analyzing section 942 may transmit the data file 182 to the index file creating section.

If it is determined that the data file 182 is video data, the analyzing section 942 attaches identification information to each piece of image data included in the data file 182. The analyzing section 942 may associate the identification information with information relating to a time sequence. The analyzing section 942 analyzes the feature information for each piece of image data. The analyzing section 942 transmits the identification information for each piece of image data and the analysis results for the corresponding piece of image data to the index file updating section 150. The analyzing section 942 transmits the identification information for the image data to the access control section 170.

The analyzing section 942 may analyze, as the feature information, the presence or ratio of color, chroma saturation, or brightness of the pixels included in the image. At this time, if the ratio of pixels having a prescribed feature is greater than a prescribed value, the analyzing section 942 may determine that pixels having this prescribed feature are present in the image. In this way, bluish pixel data, for example, can be extracted from the video data.

The analyzing section 942 may compare pieces of image data to each other and analyze changes in the images as the feature information. The analyzing section 942 may compare the image data currently being analyzed to image data that comes before the currently analyzed image data in the time sequence, and determine that there is change between the images when there is a difference between a number of pixels greater than or equal to a predetermined number. The analyzing section 942 may analyze, as the feature information of the data, the presence of this change or the content of this change.

The content of the change may be the identification numbers identifying regions where the change occurs, the identification numbers identifying the pixels included in the regions where the change occurs, the color, chroma saturation, or brightness of the pixels that have changed, or a ratio of the color, chroma saturation, or brightness change. In this way, image data in which a change has occurred in the upper left of the screen, for example, can be extracted from the video data of a surveillance camera. As another example, image data of the moment at which a fire started can be extracted from the video data of a surveillance camera.

The index file updating section 150 receives from the analyzing section 942 the identification information of the image data and the analysis results of the image data. The index file updating section 150 may update one or more index files based on the type of feature information included in the received analysis results. For example, the index file updating section 150 may update the update index file 952 when the analysis results include information in which the identification numbers of the regions where change occurs or the identification numbers of the pixels in these regions are associated with the identification information for this image data. As another example, the index file updating section 150 may update the update index file 954 when the analysis results include information in which the identification numbers of colors of pixels that experience change are associated with the identification information of this image.

The access control section 170 receives the data file 182 input from the input section 110. The identification information of the image data is received from the analyzing section 942. When the data file 182 is stored in the storage section 180, the access control section 170 updates the management file 172 using the received identification information.

With the above configuration, the information processing apparatus 900 can create an identification information list including identification information of the data files 182 that match the search conditions, and provide this list to the user. Furthermore, if the user requests access to the image data included in the identification information list, the information processing apparatus 900 can provide the user with the access destination for this image data. In a surveillance system, the number of stored frames is high but the frequency at which an image search is performed is extremely low. Therefore, the effects realized by providing the index file as a plurality of databases are even more significant.

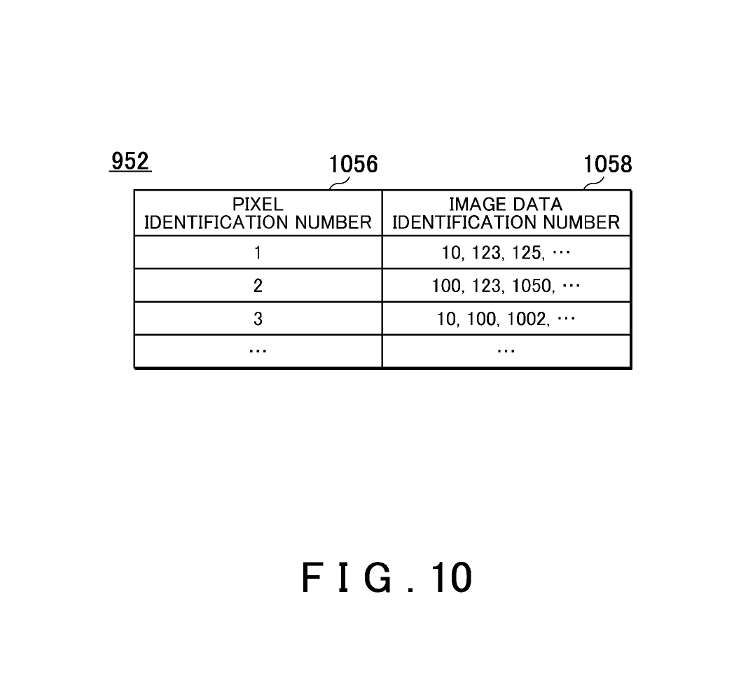

FIG. 10 is a schematic view of an exemplary data configuration of the update index file 952. The update index file 952 may store index information in which the identification numbers 1056 of pixels included in regions where change occurs are associated with the identification numbers 1058 identifying the data file and the image data. The identification numbers 1056 of the pixels are an example of feature information. The identification numbers 1058 are an example of identification information.

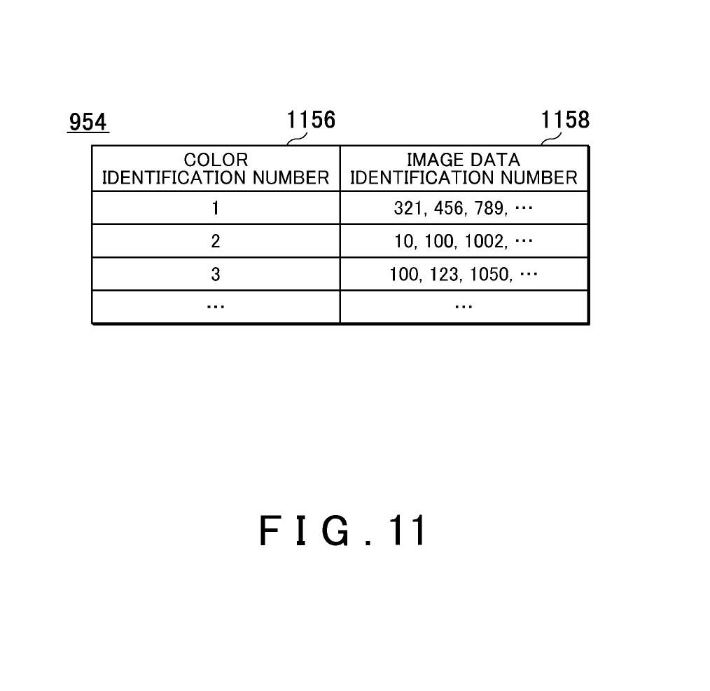

FIG. 11 is a schematic view of a data configuration of the update index file 954. The update index file 954 may store index information in which identification numbers 1156 identifying the colors of pixels included in regions where change occurs are associated with identification numbers 1158 identifying the data file and the image data. The identification numbers 1156 of the colors are an example of feature information. The identification numbers 1158 are an example of identification information.

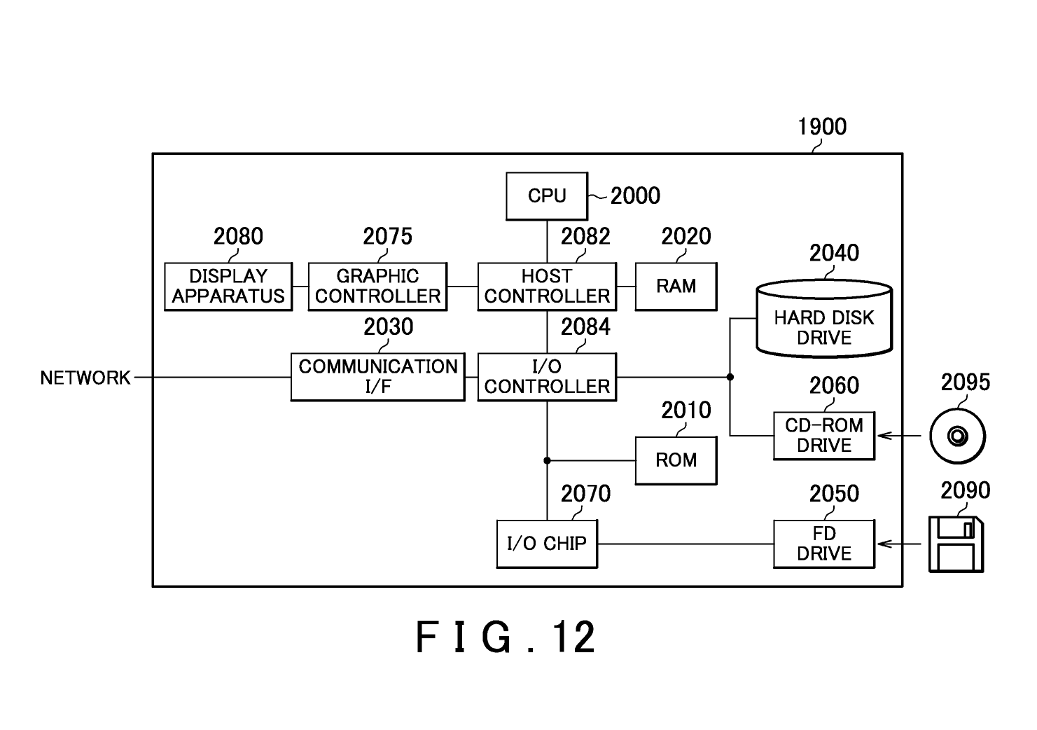

FIG. 12 shows an example of a hardware configuration of a computer 1900 according to the present embodiment. The computer 1900 according to the present embodiment is provided with a CPU peripheral including a CPU 2000, a RAM 2020, a graphic controller 2075, and a display apparatus 2080, all of which are connected to each other by a host controller 2082; an input/output section including a communication interface 2030, a hard disk drive 2040, and a CD-ROM drive 2060, all of which are connected to the host controller 2082 by an input/output controller 2084; and a legacy input/output section including a ROM 2010, a flexible disk drive 2050, and an input/output chip 2070, all of which are connected to the input/output controller 2084.

The host controller 2082 is connected to the RAM 2020 and is also connected to the CPU 2000 and graphic controller 2075 accessing the RAM 2020 at a high transfer rate. The CPU 2000 operates to control each section based on programs stored in the ROM 2010 and the RAM 2020. The graphic controller 2075 acquires image data generated by the CPU 2000 or the like on a frame buffer disposed inside the RAM 2020 and displays the image data in the display apparatus 2080. In addition, the graphic controller 2075 may internally include the frame buffer storing the image data generated by the CPU 2000 or the like.

The input/output controller 2084 connects the communication interface 2030 serving as a relatively high speed input/output apparatus, and the hard disk drive 2040, and the CD-ROM drive 2060 to the host controller 2082. The communication interface 2030 communicates with other apparatuses via a network. The hard disk drive 2040 stores the programs and data used by the CPU 2000 housed in the computer 1900. The CD-ROM drive 2060 reads the programs and data from a CD-ROM 2095 and provides the read information to the hard disk drive 2040 via the RAM 2020.

Furthermore, the input/output controller 2084 is connected to the ROM 2010, and is also connected to the flexible disk drive 2050 and the input/output chip 2070 serving as a relatively high speed input/output apparatus. The ROM 2010 stores a boot program performed when the computer 1900 starts up, a program relying on the hardware of the computer 1900, and the like. The flexible disk drive 2050 reads programs or data from a flexible disk 2090 and supplies the read information to the hard disk drive 2040 via the RAM 2020. The input/output chip 2070 connects the flexible disk drive 2050 to the input/output controller 2084 along with each of the input/output apparatuses via, a parallel port, a serial port, a keyboard port, a mouse port, or the like.

The programs provided to the hard disk drive 2040 via the RAM 2020 are stored in a storage medium, such as the flexible disk 2090, the CD-ROM 2095, or an IC card, and provided by a user. The programs are read from storage medium, installed in the hard disk drive 2040 inside the computer 1900 via the RAM 2020, and performed by the CPU 2000.

For example, if there is communication between the computer 1900 and an external apparatus or the like, the CPU 2000 performs the communication program loaded in the RAM 2020, and provides the communication interface 2030 with communication processing instructions based on the content of the process recorded in the communication program. The communication interface 2030 is controlled by the CPU 2000 to read the transmission data stored in the transmission buffer area or the like on the storage apparatus, such as the RAM 2020, the hard disc 2040, the flexible disk 2090, or the CD-ROM 2095, and send this transmission data to the network, and to write data received from the network onto a reception buffer area on the storage apparatus. In this way, the communication interface 2030 may transmit data to and from the storage apparatus through DMA (Direct Memory Access). As another possibility, the CPU 2000 may transmit the data by reading the data from the storage apparatus or communication interface 2030 that are the origins of the transmitted data, and writing the data onto the communication interface 2030 or the storage apparatus that are the transmission destinations.

The CPU 2000 may perform various processes on the data in the RAM 2020 by reading into the RAM 2020, through DMA transmission or the like, all or a necessary portion of the database or files stored in the external apparatus such as the hard disk drive 2040, the CD-ROM drive 2060, the CD-ROM 2095, the flexible disk drive 2050, or the flexible disk 2090. The CPU 2000 writes the processed data back to the external apparatus through DMA transmission or the like. In this process, the RAM 2020 is considered to be a section that temporarily stores the content of the external storage apparatus, and therefore the RAM 2020, the external apparatus, and the like in the present embodiment are referred to as a memory, a storage section, and a storage apparatus. The variety of information in the present embodiment, such as the variety of programs, data, tables, databases, and the like are stored on the storage apparatus to become the target of the information processing. The CPU 2000 can hold a portion of the RAM 2020 in a cache memory and read from or write to the cache memory. With such a configuration as well, the cache memory serves part of the function of the RAM 2020, and therefore the cache memory is also included with the RAM 2020, the memory, and/or the storage apparatus in the present invention, except when a distinction is made.

The CPU 2000 executes the various processes such as the computation, information processing, condition judgment, searching for/replacing information, and the like included in the present embodiment for the data read from the RAM 2020, as designated by the command sequence of the program, and writes the result back onto the RAM 2020. For example, when performing condition judgment, the CPU 2000 judges whether a variable of any type shown in the present embodiment fulfills a condition of being greater than, less than, no greater than, no less than, or equal to another variable or constant. If the condition is fulfilled, or unfulfilled, depending on the circumstances, the CPU 2000 branches into a different command sequence or acquires a subroutine.

The CPU 2000 can search for information stored in a file in the storage apparatus, the database, and the like. For example, if a plurality of entries associated respectively with a first type of value and a second type of value are stored in the storage apparatus, the CPU 2000 can search for entries fulfilling a condition designated by the first type of value from among the plurality of entries stored in the storage apparatus. The CPU 2000 can then obtain the second type of value associated with the first type of value fulfilling the prescribed condition by reading the second type of value stored at the same entry.

The programs and modules shown above may also be stored in an external storage medium. The flexible disk 2090, the CD-ROM 2095, an optical storage medium such as a DVD or CD, a magneto-optical storage medium, a tape medium, a semiconductor memory such as an IC card, or the like can be used as the storage medium. Furthermore, a storage apparatus such as a hard disk or RAM that is provided with a server system connected to the Internet or a specialized communication network may be used to provide the programs to the computer 1900 via the network.

The programs that are installed on the computer 1900 and cause the computer 1900 to function as the search device, the search system, and each of the components in the search device and search system include modules for which the operation of each component is defined. These programs and modules prompt the CPU 2000 or the like to make the computer 1900 function as the search device, the search system, and each of the components in the search device and search system.

The information processes recorded in these programs are read by the computer 1900 to cause the computer 1900 to function as software and hardware described above. With these specific sections, a unique search device or search system, such as the information processing apparatus 100, the information processing apparatus 700, or the information processing apparatus 900, suitable for an intended use can be configured to function by realizing the calculations or computations appropriate for the intended use of the computer 1900 of the present embodiment.

The above describes a method that includes acquiring extraction target information indicating a feature of data to be extracted; referencing a plurality of index files, which each associate pieces of feature information indicating features of a plurality of pieces of data with identification information identifying each piece of data, and extracting from the index files the identification information associated with feature information relating to the extraction target information; and determining whether there are identical pieces of identification information among the extracted pieces of identification information, and creating an identification information list that does not include copies of identical pieces of identification information. Also described is a program that causes a computer to perform this method.

Furthermore, the above describes a method of a server providing service to a client terminal via a network. This service includes acquiring extraction target information indicating a feature of data to be extracted; referencing a plurality of index files, which each associate pieces of feature information indicating features of a plurality of pieces of data with identification information identifying each piece of data, and extracting from the index files the identification information associated with feature information relating to the extraction target information; and determining whether there are identical pieces of identification information among the extracted pieces of identification information, and creating an identification information list that does not include copies of identical pieces of identification information. Also described is a program that causes a computer to perform this method.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A search device comprising:
an acquiring section that acquires extraction target information indicating a feature of data to be extracted;
an identification information extracting section that references a plurality of index files, which each associate pieces of feature information indicating features of a plurality of pieces of data with identification information identifying each piece of data, and extracts from the index files the identification information associated with feature information relating to the extraction target information; and
a list creating section that determines whether there are identical pieces of identification information among the pieces of identification information extracted by the identification information extracting section, and creates an identification information list that does not include copies of identical pieces of identification information.

2. The search device according to claim 1, wherein
the pieces of feature information include information indicating a feature relating to a portion of each of the pieces of data.

3. The search device according to claim 1, further comprising an index file updating section that updates an index file, wherein
the index file updating section updates a first index file until a predetermined event occurs, and
when the predetermined event occurs, the index file updating section creates a second index file based on the first index file.

4. The search device according to claim 1, further comprising an access information extracting section that references a management file, in which the identification information for each piece of data is associated with access information indicating an access destination for the corresponding piece of data, and extracts from the management file the access information associated with the pieces of identification information that match the pieces of identification information included in the identification information list.

5. The search device according to claim 4, further comprising:
a plurality of storage apparatuses that store the data; and
a management server that stores the management file and exchanges information with each of the storage apparatuses via a network.

6. The search device according to claim 4, further comprising an index file updating section that updates an index file, wherein
the index file updating section updates a first index file until a predetermined event occurs, and
when the predetermined event occurs, the index file updating section creates a second index file based on the first index file.

7. The search device according to claim 1, further comprising:
a request receiving section that receives a search request including the extraction target information from a user; and
an output section that presents the user with the identification information list, as a search result for the search request.

8. The search device according to claim 1, wherein
the search device is a search system including a client terminal, and a server that exchanges information with the client terminal via a network, wherein
the server includes the acquiring section, the identification information extracting section, and a transmitting section that transmits the pieces of identification information extracted by the identification information extracting section to the client terminal, and
the client terminal includes the list creating section.

9. A method comprising:
acquiring extraction target information indicating a feature of data to be extracted;
referencing a plurality of index files, which each associate pieces of feature information indicating features of a plurality of pieces of data with identification information identifying each piece of data, and extracting from the index files the identification information associated with feature information relating to the extraction target information; and
determining whether there are identical pieces of identification information among the extracted pieces of identification information, and creating an identification information list that does not include copies of identical pieces of identification information.

10. The method according to claim 9, wherein
the pieces of feature information include information indicating a feature relating to a portion of each of the pieces of data.

11. The method according to claim 9, further comprising updating an index file, wherein updating the index file includes:
updating a first index file until a predetermined event occurs, and
when the predetermined event occurs, creating a second index file based on the first index file.

12. The method according to claim 9, further comprising referencing a management file, in which the identification information for each piece of data is associated with access information indicating an access destination for the corresponding piece of data, and extracting from the management file the access information associated with the pieces of identification information that match the pieces of identification information included in the identification information list.

13. The method according to claim 12, further comprising updating an index file, wherein updating the index file includes:
updating a first index file until a predetermined event occurs, and
when the predetermined event occurs, creating a second index file based on the first index file.

14. A method of a server providing service to a client terminal via a network, wherein the service includes:
acquiring extraction target information indicating a feature of data to be extracted;
referencing a plurality of index files, which each associate pieces of feature information indicating features of a plurality of pieces of data with identification information identifying each piece of data, and extracting from the index files the identification information associated with feature information relating to the extraction target information; and
determining whether there are identical pieces of identification information among the extracted pieces of identification information, and creating an identification information list that does not include copies of identical pieces of identification information.

15. A computer readable medium storing thereon a program for a search device, the program causing the computer to function as the search device of claim 1.

16. A computer readable medium storing thereon a program for a search device, the program causing the computer to function as the search device of claim 2.

17. A computer readable medium storing thereon a program for a search device, the program causing the computer to function as the search device of claim 3.

18. A computer readable medium storing thereon a program for a search device, the program causing the computer to function as the search device of claim 4.

19. A computer readable medium storing thereon a program for a search device, the program causing the computer to function as the search device of claim 5.

20. A computer readable medium storing thereon a program for a search device, the program causing the computer to perform the method of claim 14.
